(19) United States
(12) Patent Application Publication
(10) Pub. No.: US 2008/0283354 A1
(43) Pub. Date: Nov. 20, 2008

(54) Device For Locking a Vehicle Transmission and Corresponding Manufacturing Method

(75) Inventors: Michel Buannec, Verneuil Sur Seine (FR); Philippe Cloud, Montigny-le-Breronneux (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S.A.S., Boulogne Billancourt (FR)

(21) Appl. No.: 11/995,833

(22) PCT Filed: Jun. 14, 2006
(86) PCT No.: PCT/FR2006/050555

§ 371 Date: Jul. 24, 2008

(30) Foreign Application Priority Data
Jul. 21, 2005 (FR) 0552265

(51) Int. Cl. B60W 10/18

(52) U.S. Cl. 192/219.5

(57) ABSTRACT

A device for locking a vehicle transmission including a toothed wheel connected to the vehicle drive wheels via a transmission element, and a locking pivoting finger capable of being engaged between two consecutive teeth of the toothed parking wheel to immobilize the drive wheels via the toothed parking wheel. The toothed parking wheel is integrated in the differential ring gear.

The present invention relates to the locking of a vehicle transmission of the parking brake type, comprising a toothed parking wheel connected to the vehicle drive wheels by an element of the transmission, and a pivoting locking pawl which can engage between two consecutive teeth of the parking wheel so as to immobilize the drive wheels via said parking wheel.

This invention finds a preferred, although nonlimiting, application in an automatic transmission with planetary gear sets or in an automated gear transmission.

Every vehicle must be able to be immobilized independently of the handbrake. With a manual gear transmission, this immobilization is achieved by locking the transmission through the manual engagement of a gear ratio by means of the gear lever. In the absence of a true gearshift lever, that is to say in the absence of a direct mechanical connection between the driver's lever or selector and the gearbox, use is made of “parking brake” systems generally comprising a rotating part, or parking wheel, at the transmission output, and a pivoting pawl capable of rotationally immobilizing the parking wheel and the transmission.

In a conventional arrangement, illustrated by publication FR 2664957, the parking wheel is mounted at the output of a planetary gear set of the gearbox. In the absence of a planetary gear set, in particular in the case of automated gearboxes, it is necessary to find other locations, on rotating parts of the transmission. In this regard, publication DE 102 44 395 proposes integrating the parking wheel on the differential by directly machining a series of toothings on the casing. Apart from the manufacturing difficulties, this solution has the major drawback of being very constraining, since any new dimensioning of the parking wheel necessarily involves the production of a new differential casing.

The object of the present invention is to facilitate the manufacture and the adaptation of a locking device to any type of transmission.

To this end, the present invention proposes integrating the parking wheel into the ring gear of the differential.

According to a first embodiment, the input pinion of the differential ring gear is mounted inside the bearings of the shaft which carries this pinion.

According to a second embodiment, the input pinion of the differential ring gear is mounted outside the bearings of the shaft which carries this pinion.

Other features and advantages of the present invention will become more clearly apparent from the description given below of a nonlimiting embodiment of the invention, with reference to the appended drawings, in which:

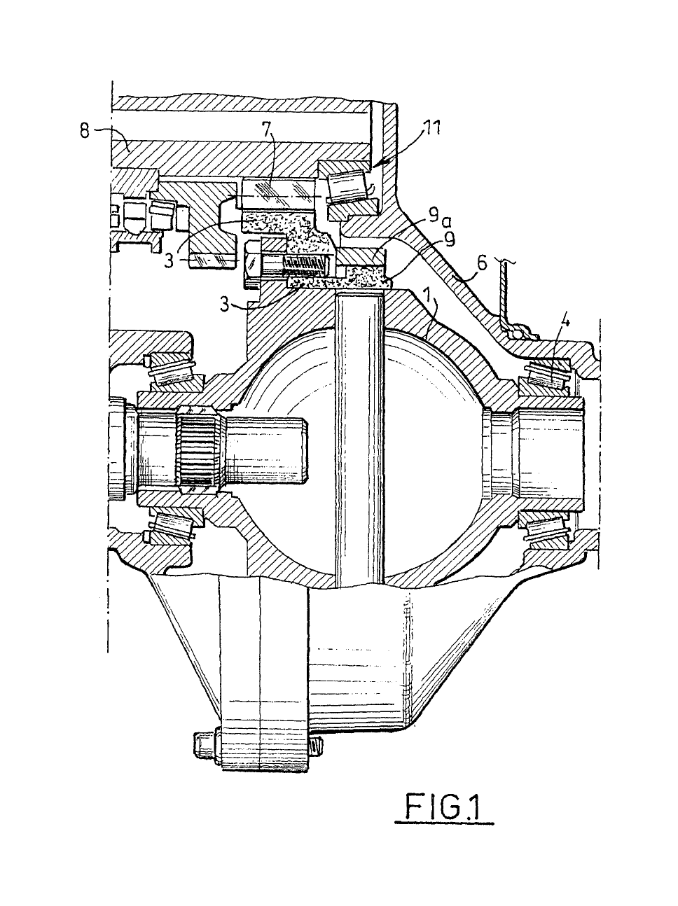

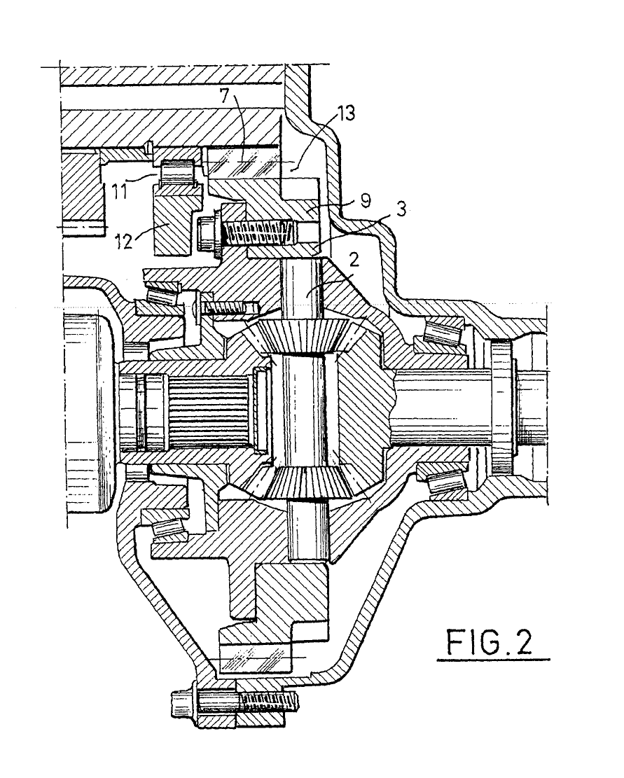

FIGS. 1 and 2 illustrate two embodiments of the invention.

In the figures, there is represented a transmission differential casing 1, with its planet gear-carrying pin 2 and its ring gear 3. The casing is supported by bearings 4, in the clutch housing 6 of the transmission. The ring gear 3 is engaged with a differential input pinion 7 carried by a secondary shaft 8 of the gearbox 6.

Specifically, the transmission in question has at least two parallel shafts, including a primary shaft and a secondary shaft 8, supporting a plurality of pinions, including an input pinion 7 of the differential ring gear. This transmission may be a “twin-clutch” transmission, comprising two input clutches connected to two concentric primary shafts, and two secondary shafts. However, these applications are not limiting and, generally, the invention applies to any type of manual or robotized transmission with parallel shafts and gears, or automatic transmission with one or more planetary gear sets.

According to the invention, the parking wheel 9 is integrated into a differential ring gear 3 of any type of transmission. The wheel 9 is provided on its periphery with a set of teeth 9a which cooperates with a pivoting locking pawl (not shown) which can engage between two consecutive teeth 9a so as to immobilize the drive wheels.

In FIG. 1, it can be seen that the input pinion 7 of the differential ring gear 3 is arranged inside the bearings 11 of the shaft 8 which carries this pinion (secondary shaft of the gearbox), while in FIG. 2 it is arranged outside the bearings 11. This second arrangement requires the addition of an additional part in the gearbox, such as an internal cover 12 fastened to the clutch housing 6 in order to carry the bearings 11 of the shaft 8. It has the advantage of making available a free space 13, which does not appear in FIG. 1, above the axis of the differential. The space 13 can advantageously be occupied by part of the control mechanism (not shown) for the pivoting pawl, thereby making it possible to reduce the effective space requirement of the mechanism in the gearbox.

According to the invention, the toothing of the parking wheel 9 can be produced by being forged into the differential ring gear 3. This integration makes it possible to eliminate a number of separate parts, including the toothed wheel itself, but also the conventional fastening elements (screws, clips etc.) which are used to fasten it to a rotating part of the transmission. Moreover, with regard to integrating the toothed wheel into the casing itself, the solution proposed has the advantage of being able to keep the same casing for different applications, since this casing is able to accommodate ring gears of varying dimensions depending on the characteristics of the transmissions in which it is used.

The ring gear can be machined following the forging of the parking wheel in order to obtain a better finishing of the teeth if that is desired. The machining operations thus preferably include the drilling of the holes for fastening the ring gear to the differential casing, and the centering of the ring gear on the casing. Finally, the holes for fastening the ring gear to the casing can open into the gaps between the teeth 9a of the parking wheel 9.

In conclusion, the invention offers numerous advantages over the solutions known from the prior art, including its ease of implementation, since it is simpler to forge a differential ring gear than the differential casing itself, and since the simple forging of the teeth of the toothed wheel into the mass of the differential ring gear can provide a sufficient precision of the teeth of the parking wheel for the function which is demanded of it.

1-10. (canceled)

11. A device for locking a vehicle transmission comprising:
a toothed parking wheel connected to the vehicle drive wheels by an element of the transmission; and
a pivoting locking pawl that can engage between two consecutive teeth of the parking wheel so as to immobilize the drive wheels via the parking wheel,
wherein the parking wheel is forged into a ring gear of a differential.

12. A vehicle transmission comprising:
a locking device as claimed in claim 11, wherein an input pinion of the differential ring gear is mounted inside bearings of a shaft that carries the pinion.

13. A vehicle transmission comprising:
a locking device as claimed in claim 11, wherein an input pinion of the differential ring gear is mounted outside bearings of a shaft that carries the pinion.

14. The transmission as claimed in claim 13, wherein the bearings are mounted on an internal bearing-carrying cover.

15. The transmission as claimed in claim 14, wherein the internal cover is fastened to a clutch housing.

16. The transmission as claimed in claim 12, comprising at least two parallel shafts supporting a plurality of pinions.

17. The transmission as claimed in claim 12, comprising at least two concentric primary shafts, and a secondary shaft carrying an input pinion of the differential ring gear.

18. A method of manufacturing a transmission-locking toothed parking wheel, comprising:
forging toothing of the parking wheel into a mass of a differential ring gear of the transmission.

19. The manufacturing method as claimed in claim 18, wherein the ring gear is machined following the forging of the parking wheel to finish the teeth.

20. The manufacturing method as claimed in claim 19, wherein the ring gear machining includes drilling holes for fastening the ring gear to a differential casing and centering the ring gear on the casing.
